(19) United States
(12) Patent Application Publication
(10) Pub. No.: US 2024/0280174 A1
(43) Pub. Date: Aug. 22, 2024

(54) PARKING LOCK SHIFTING DEVICE, TRANSMISSION SHIFTING DEVICE, TRANSMISSION AND VEHICLE

(71) Applicant: ZF Friedrichshafen AG, Friedrichshafen (DE)

(72) Inventors: Johannes Glückler, Friedrichshafen (DE); Bernard Hunold, Friedrichshafen (DE); Michael Preuß, Friedrichshafen (DE); Alexander Thorwart, Langenargen (DE)

(73) Assignee: ZF Friedrichshafen AG, Friedrichshafen (DE)

(21) Appl. No.: 18/414,975

(22) Filed: Jan. 17, 2024

(30) Foreign Application Priority Data
Jan. 18, 2023 (DE) 10 2023 200 350.3

(51) Int. Cl. F16H 63/34

(52) U.S. Cl. CPC F16H 63/3416

(57) ABSTRACT

A parking lock shifting device has a flat cam mechanism with a rotatable cam element and an engagement element guided on the cam element and displaceable for shifting a parking lock. A transmission shifting device has a rotatable shift roller and at least one shift element which can be displaced by rotating the shift roller. The transmission shift device has such a parking lock shifting device, the cam element is non-rotatably connected to the shift drum and the engagement element forms a further shift element which can be shifted by rotating the shift drum. Also disclosed is a transmission with a parking lock shifting device of this type or a transmission shifting device of this type, and vehicle with a parking lock shifting device of this type, a transmission shifting device of this type or a transmission of this type.

### RELATED APPLICATIONS

This application claims the benefit of and right of priority under 35 U.S.C. § 119 to German Patent Application no. 10 2023 200 350.3, filed on 18 Jan. 2023, the contents of which are incorporated herein by reference in its entirety.

### FIELD OF THE DISCLOSURE

The invention relates to a parking lock shifting device. The invention also relates to a transmission shifting device with a rotatable shifting drum and at least one shifting element which can be displaced by rotating the shifting drum. The invention also relates to a transmission. The invention also relates to a vehicle.

### BACKGROUND

Document EP 3 736 471 A2 relates to a drum transmission device comprising a transmission shaft configured to drive at least one wheel of a vehicle, a drum element configured to perform a gear shifting operation, a transmission actuating shaft configured to rotate the drum element, and a parking lock mechanism. The parking lock mechanism comprises a parking gear configured to be provided on the transmission shaft so as to be relatively non-rotatable, a parking actuator arm configured to be slidable between a locking position in which the parking actuator arm is engaged with the parking gear and an unlocking position in which the parking actuator arm is disengaged from the parking gear, a parking release spring configured to urge the parking actuator arm toward the unlocking position, and a parking slide element configured to urge the parking actuator arm toward the unlocking position, a parking release spring configured to push the parking actuator arm toward the unlocking position, and a parking slide element configured to slide the parking actuator arm from a shift position or a neutral position to a parking position in accordance with rotation of the drum element. An end of the transmission operating shaft is disposed near the parking operating arm, wherein an arm retaining portion capable of urging the parking operating arm toward the unlocking position when the drum element rotates from the parking position to the shifting position or the neutral position is provided at the one end of the transmission operating shaft.

Document DE 10 2019 205 747 A1 relates to a transmission with an input shaft, a first output shaft, a second output shaft, a first planetary gear set and a second planetary gear set connected to the first planetary gear set. The planetary gear sets each comprise several elements, the first output shaft is non-rotatably connected to a second element of the first planetary gear set, the second output shaft is non-rotatably connected to a third element of the second planetary gear set, a third element of the first planetary gear set is non-rotatably connected to a first element of the second planetary gear set via a shaft and a second element of the second planetary gear set is fixed to a non-rotatable component. The transmission further comprising a third planetary gear set with three elements and two shifting elements, wherein a first shifting element is designed to lock the third planetary gear set by non-rotatably connecting two of its elements, a second shifting element is designed to fix a first element of the third planetary gear set to the non-rotatable component, a second element of the third planetary gear set is non-rotatably connected to the first element of the first planetary gear set via an intermediate shaft, and a third element of the third planetary gear set is non-rotatably connected to the input shaft.

### SUMMARY

The invention is based on the task of structurally and/or functionally improving a parking lock shifting device mentioned at the beginning. In addition, the invention is based on the task of structurally and/or functionally improving a transmission shifting device mentioned at the beginning. The invention is also based on the task of structurally and/or functionally improving a transmission as mentioned above. The invention is also based on the task of structurally and/or functionally improving a vehicle mentioned at the beginning.

The problem is solved with a parking lock shifting device, a transmission shifting device, a transmission, and a vehicle including such components, as disclosed herein. Advantageous embodiments and/or further developments will be apparent in light of the present disclosure.

The parking lock shifting device can be designed to shift a parking lock. The parking lock can have a parking lock wheel and a parking lock pawl. The parking lock wheel can be connected or connected to a shaft so that it cannot rotate. The shaft can be mounted on a housing or frame of a transmission. The parking lock can be designed to lock and/or release the shaft's ability to rotate. The parking lock wheel can have a locking contour. The locking contour can have recesses. The parking lock pawl can be mounted on a transmission housing or frame. The parking lock pawl can be moved between a release position, in which the parking lock is released, and a locking position, in which the parking lock is active. The parking lock pawl can have a locking cam. In the release position, the locking cam can be disengaged. In the locking position, the locking cam can engage positively with the locking contour of the parking lock wheel. The parking lock pawl can be displaced using the parking lock shifting device.

The cam element can have a curve. The cam element can have a disk-like shape. The cam element can have at least one cam disk. The cam element can have a first cam disk and a second cam disk. The first cam disk and the second cam disk can be arranged parallel to each other and at a distance from each other. The first cam disk and the second cam disk can be connected to each other so that they cannot rotate. The first cam disk and the second cam disk can have sides facing each other. The cam can be arranged on the sides of the cam disks facing each other. The cam can be designed as a guide for the engagement element. The curve can be designed as a guide groove or guide rail.

The cam element can be rotated about an axis of rotation. Unless otherwise stated or unless otherwise apparent from the context, the terms “axial”, “radial” and “circumferential” refer to the axis of rotation of the cam element. “Axial” then corresponds to an extension direction of the rotation axis of the cam element. “Radial” is then a direction perpendicular to the direction of extension of the axis of rotation of the cam element and intersecting with the axis of rotation of the cam element. “In circumferential direction” then corresponds to a circular arc direction around the axis of rotation of the cam element.

The engagement element can have a geometrically complementary shaped section corresponding to a cross-section of a curve designed as a guide groove or guide rail. The engagement element can be straight or linear. The engagement element can be guided in a radial direction.

The cam element and the engagement element can be movable in a common plane. The engagement element can be displaced radially to the cam element. The cam element and the engagement element can be mounted on a housing or frame of a transmission. The engagement element can be displaceable or shiftable between a release position, in which the parking lock is released, and a locking position, in which the parking lock is active.

The curve can run at a radial distance from the axis of rotation. The curve can run from the axis of rotation in the circumferential direction and/or in the radial direction. The curve can extend in a radial direction over an angular range of more than 270°. The curve can extend in a radial direction over an angular range of approx. 360°.

The curve can have a first cam section for holding the engagement element in the release position. At the first cam section, the curve can have a constant distance from the axis of rotation. The curve can have a second cam section for shifting the engagement element to the locking position. At the second cam section, the curve can have an increasing distance from the axis of rotation. The curve can have a third cam section for holding the engagement element in the locked position. At the third cam section, the curve can have a constant distance from the axis of rotation. The curve can have a fourth cam section for shifting the engagement element to the release position. At the fourth cam section, the curve can have a constant distance from the axis of rotation.

The first cam section, the second cam section, the third cam section and the fourth cam section can be arranged in numerically ordered succession. The first cam section, the second cam section, the third cam section and the fourth cam section can be functionally effective cam sections. Functional effectiveness can result from the interaction of the curve with the meshing element. At least one cam section can be multifunctional. At least one cam section can be reversed or converted. The second cam section and the fourth cam section can be formed by reversing the direction of rotation with a common structural cam section. The third cam section can be formed with a cam end point, in particular with an end point of the curve.

When the cam element is rotated in a first direction of rotation, starting from an effective first cam section, the second cam section and then the third cam section can become/be effective. When the cam element is rotated in a second direction of rotation opposite to the first direction of rotation, the fourth cam section can subsequently become/be effective, starting from an effective third cam section.

The cam element can have a curve with a further cam section. The further cam section can be designed for emergency unlocking of the parking lock. An emergency release can be designed to unlock the parking lock if it cannot be operated using the actuator. The additional cam section can be designed to shift the engagement element to the release position. At the further cam section, the curve can have a decreasing distance from the axis of rotation. The next cam section can be connected to the fourth cam section. When the cam element is rotated in the second direction of rotation, starting from an effective fourth cam section, the further cam section can subsequently become/be effective.

The parking lock shifting device can have a drive. The drive can be designed to rotate the cam element. The drive can have an actuator and/or a transmission. The actuator can be designed to automatically rotate the cam element. The actuator can be an electric, pneumatic or hydraulic actuator. The actuator can be controlled using electrical signals. The actuator can be controlled using a control unit. The actuator can be a rotary actuator. The actuator can have an actuator rotation axis. The actuator can be arranged with its actuator axis of rotation perpendicular to the axis of rotation of the cam element. The transmission can be designed to convert the mechanical drive power of the actuator. The transmission can be designed to redirect a drive torque and/or a drive movement of the actuator. The transmission can be designed to deflect a rotary movement around the actuator's axis of rotation by 90°. The transmission can have at least one gearwheel. The transmission can have a bevel gear pairing.

The parking lock shifting device can have a manual actuation for turning the cam element. The manual actuation can have a traction device. The manual actuation can have a cable pull or a Bowden cable. The manual operation can have a stop or a pull limit. The manual operation can have a freewheel. The manual actuation can be connected to the cam element and/or detached from the cam element. A detachable form-fit connection can be effective between the manual actuation and the cam element. The actuation and the cam element can have geometrically complementary corresponding positive locking sections. The actuation can have a T-pin-shaped positive locking section. The cam element can have a groove-shaped positive locking section. The T-pin-shaped positive locking section can be brought into or out of engagement with the cam element by rotating it through 90°.

The parking lock shifting device can have an actuating element. The actuating element can be designed to actuate the parking lock pawl. The actuating element can have a ramp section. The actuating element can have a conical shape. The actuating element can be connected to the engagement element and can be displaced to a limited extent relative to the engagement element. The actuating element can be guided on the actuating element. Displacement of the actuating element on the engagement element can be limited by a stop. A mechanical energy store can be effective between the engagement element and the actuating element. The mechanical energy store can be designed as a spring, in particular as a compression spring and/or coil spring.

The transmission shifting device can be designed to shift a transmission. The transmission shifting device can be designed to shift gears of a transmission. The transmission shifting device can be designed for sequential shifting of gears of a transmission.

The shifting roller can be rotated about an axis of rotation. The shift drum can be mounted on a transmission housing or frame. The axis of rotation of the shifting roller and the axis of rotation can be coaxial. The shifting roller and the cam follower can have a common axis of rotation. The shifting roller can have at least one guide for the at least one shifting element. The at least one guide can be arranged radially on the outside of the shifting roller. The at least one guide can extend in the circumferential direction and/or in the axial direction. The at least one guide can be designed as a guide groove or guide rail.

The at least one shifting element can be axially displaceable. The at least one shifting element can be mounted on a housing or frame of a transmission in a rotationally fixed and axially displaceable manner. The at least one shifting element can be guided on the guide of the shifting roller. The at least one shifting element can have a shaped section that corresponds geometrically complementary to a cross-section of at least one guide designed as a guide groove or guide rail. The at least one shifting element can be guided in an axial direction on the shifting column. The at least one shifting element can be designed for direct or indirect shifting. The at least one shifting element can be designed as a shifting fork or claw shifting element.

The transmission shifting device can have a first shifting element. The first shifting element can be shifted to a neutral position and/or a shifting position by turning the shifting roller. The transmission shifting device can have a second shifting element. The second shifting element can be shifted to a first shifting position, a neutral position and/or a second shifting position by turning the shifting roller. The transmission shifting device can have a further shifting element. The additional shifting element or the engagement element can be shifted to a neutral position and/or a shifting position. Turning the shifting roller with the engagement element can cause the first shifting element, the second shifting element and the further shifting element or the engagement element to shift together.

The transmission shifting device can have a drive. The drive of the parking lock shifting device can also be designed as a drive of the transmission shifting device. The drive of the parking lock shifting device can be designed as a joint drive of the parking lock shifting device and the transmission shifting device. The shift roller can be rotated automatically using the drive.

The shifting roller can be rotated into a first rotational position in which the first shifting element is shifted to its neutral position, the second shifting element is shifted to its first shifting position and the further shifting element is shifted to its shifting position. The shift roller can be rotated into a second rotational position in which the first shift element is shifted to its neutral position, the second shift element is shifted to its first shift position and the further shift element is shifted to its neutral position. The shifting roller can be rotated into a third rotational position in which the first shifting element is shifted to its neutral position, the second shifting element is shifted to its neutral position and the further shifting element is shifted to its neutral position. The shifting roller can be rotated into a fourth rotational position, in which the first shifting element is shifted to its neutral position, the second shifting element to its second shifting position and the further shifting element to its neutral position. The shifting roller can be rotated to a fifth rotational position in which the first shifting element is shifted to its neutral position, the second shifting element is shifted to its neutral position and the further shifting element is shifted to its neutral position. The shifting roller can be rotated to a sixth rotational position, in which the first shifting element is shifted to its shifting position, the second shifting element to its neutral position and the further shifting element to its neutral position.

The shift drum can be rotated manually. The shift drum can be rotated using manual operation. The shifting roller can be rotated into a first further rotational position in which the first shifting element is shifted to its neutral position, the second shifting element is shifted to its neutral position and the further shifting element is shifted to its shifting position. The shifting roller can be rotated into a second further rotational position in which the first shifting element is shifted to its neutral position, the second shifting element is shifted to its neutral position and the further shifting element is shifted to its neutral position.

The first rotational position, the second rotational position, the third rotational position, the fourth rotational position, the fifth rotational position and the sixth rotational position can be run through numerically in ascending or descending order depending on the direction of rotation when the shifting roller is rotated. The first further rotational position and the second further rotational position can be run through numerically in ascending or descending order depending on the direction of rotation when the shifting roller is rotated. The first further rotational position and the second further rotational position can be traversed when the shifting roller is rotated from the first rotational position in a direction of rotation opposite to the second rotational position.

The transmission can be designed for use in a drive train or a vehicle. The drive train can have an electric drive unit. The electric drive machine can have a stator and a rotor. The electric drive machine can be designed and/or arranged to drive the input shaft. The electric drive machine can be controlled using electrical signals, using a control unit, using program commands and/or taking sensor signals into account. The drive train can have at least one drivable vehicle wheel. The drivetrain can have a first drivable vehicle wheel. The first drivable vehicle wheel can be non-rotatably connected to the first output shaft. The drivetrain can have a second drivable vehicle wheel. The second drivable vehicle wheel can be non-rotatably connected to the second output shaft. The transmission can have an input shaft that can be driven by the drive unit. The parking lock can be located on the input shaft.

The transmission can have an input shaft, an upshift transmission, a main transmission with a first planetary gear set and a second planetary gear set, a first output shaft assigned to the first planetary gear set and a second output shaft assigned to the second planetary gear set. The upshift transmission can be designed as a countershaft transmission. The parking lock can be arranged on the upshift transmission, in particular on the input shaft.

The upshift transmission can be effective and/or arranged between the input shaft and the main transmission. The main transmission can be effective and/or arranged between the upshift transmission and the output shafts. The transmission can have a main axle. The main axis, the axis of rotation of the shifting roller and the axis of rotation of the cam element can be coaxial. The transmission can have a fixed housing or frame.

The input shaft can have an input shaft axis. The input shaft axis can be coaxial to the main axis. The input shaft can be guided into and/or out of the housing or frame. The input shaft can be rotatably mounted in the housing or frame. The input shaft can be driven by a drive unit. The input shaft can be designed as a hollow shaft.

The main transmission can be designed as a differential transmission or differential transmission. The main transmission can be designed to distribute mechanical power from the input shaft to the first output shaft and the second output shaft. The main transmission can be designed to enable speed compensation between the first output shaft and the second output shaft. The main transmission can be designed as a spur gear differential in planetary design. The main transmission can form an integrated differential of the transmission.

The main transmission can be an epicyclic or planetary transmission. The main transmission can be a multi-stage transmission, in particular a two-stage transmission. The first planetary gear set can be effective and/or arranged between the upshift transmission and the second planetary gear set. The first planetary gear set can have a sun gear, planet gears, a planet carrier and a ring gear. The sun gear, the planet carrier and the ring gear of the first planetary gear set can form elements of the first planetary gear set. The second planetary gear set can have a sun gear, planet gears, a planet carrier and a ring gear. The sun gear, the planet carrier and the ring gear of the second planetary gear set can form elements of the second planetary gear set.

The first output shaft can be assigned to the first planetary gear set in such a way that the first output shaft is non-rotatably connected to an element of the first planetary gear set. The first output shaft can have a first output shaft axis. The first output shaft axis can be coaxial to the main axis. The first output shaft can be guided into and/or out of the housing or frame. The first output shaft can be rotatably mounted in the housing or frame. The first output shaft can be designed as a solid shaft.

The second output shaft can be assigned to the second planetary gear set in such a way that the second output shaft is non-rotatably connected to an element of the second planetary gear set. The second output shaft can have a second output shaft axis. The second output shaft axis can be coaxial to the main axis. The second output shaft can be guided into and/or out of the housing or frame. The second output shaft can be rotatably mounted in the housing or frame. The second output shaft can be designed as a solid shaft.

The main transmission can have an input shaft, a first output shaft and a second output shaft. The first output shaft of the main transmission and the first output shaft of the transmission can be structurally and/or functionally connected to each other. The first output shaft of the transmission can form a first output shaft of the main transmission. The second output shaft of the main transmission and the second output shaft of the transmission can be structurally and/or functionally connected to each other. The second output shaft of the transmission can form a second output shaft of the main transmission.

The planet carrier of the first planetary gear set and the first output shaft can be non-rotatably connected to each other. The ring gear of the first planetary gear set and the sun gear of the second planetary gear set can be non-rotatably connected to each other. The planet carrier of the second planetary gear set can be non-rotatably connected to the housing or frame. The ring gear of the second planetary gear set and the second output shaft can be non-rotatably connected to each other.

The upshift transmission can be designed to change a torque and/or a mechanical speed from the input shaft of the transmission before it is fed into the main transmission. The upshift transmission can have an input shaft and an output shaft. The input shaft of the upshift transmission and the input shaft of the transmission can be structurally and/or functionally connected to each other. The input shaft of the transmission can form an input shaft of the upshift transmission. The output shaft of the upshift transmission and the input shaft of the main transmission can be structurally and/or functionally connected to each other. The output shaft of the upshift transmission can form an input shaft of the main transmission. The input shaft of the main transmission can form an output shaft of the upshift transmission. A combined input shaft of the main transmission and output shaft of the upshift transmission can also be referred to as an intermediate shaft. The output shaft of the upshift transmission and/or the input shaft of the main transmission can have a shaft axis. The shaft axis of the output shaft of the upshift transmission and/or the shaft axis of the input shaft of the main transmission can be coaxial to the main axis. The output shaft of the upshift transmission and/or the input shaft of the main transmission can be rotatably mounted in the housing or frame. The output shaft of the upshift transmission and/or the input shaft of the main transmission can be designed as a hollow shaft.

The upshift transmission can be a stationary transmission. The upshift transmission can be designed to provide a first upshift gear, a second upshift gear and a third upshift gear. The first upshift gear, the second upshift gear and the third upshift gear can each have different ratios. The upshift transmission can have a first gear set level, a second gear set level and a third gear set level. The first upshift gear can be represented using the first gear set level and the third gear set level. The second upshift gear can be represented using the first gear set level and the second gear set level. The third upshift gear can be represented as a direct gear between the upshift transmission and the main transmission.

The upshift transmission can have at least one countershaft. The upshift transmission can have a first countershaft and a second countershaft. The first countershaft and the second countershaft can be of identical design. The upshift transmission must have a single countershaft. The first countershaft, the second countershaft and/or the single countershaft can also be referred to here as “at least one countershaft”. The at least one countershaft can have a countershaft axle. The countershaft axis can be parallel to the main axis and at a distance from the main axis. The at least one countershaft can be rotatably mounted in the housing or frame. The at least one countershaft can be designed as a solid shaft.

The gear set levels can each have a first gear wheel and at least one second gear wheel toothed with the first gear wheel. The first gearwheel and the at least one second gearwheel can each represent or form an upshift gear with a transmission ratio. The first gear wheel of the first gear set level can be connected to the input shaft of the transmission so that it cannot rotate. The at least one second gear wheel of the first wheel set level can be connected to the at least one countershaft in a rotationally fixed manner. The first gear wheel of the second gear set level can be rotatably arranged on the output shaft of the upshift transmission and/or the input shaft of the main transmission. The at least one second gear wheel of the second wheel set level can be connected to the at least one countershaft in a rotationally fixed manner. The first gearwheel of the third gear set level can be rotatably arranged on the output shaft of the upshift transmission and/or the input shaft of the main transmission. The at least one second gear wheel of the third wheel set level can be connected to the at least one countershaft in a rotationally fixed manner.

The upshift transmission can have a first shiftable connection. The first shiftable connection can be designed to connect the input shaft of the transmission on the one hand and the output shaft of the upshift transmission and/or the input shaft of the main transmission on the other hand in a rotationally fixed manner depending on the shift position. The first shiftable connection can be shiftable between a first shift position, in which the input shaft of the transmission on the one hand and the output shaft of the upshift transmission and/or the input shaft of the main transmission on the other hand are rotatable relative to each other, and a second shift position, in which the input shaft of the transmission on the one hand and the output shaft of the upshift transmission and/or the input shaft of the main transmission on the other hand are non-rotatably connected to each other. The first shiftable connection can be designed as a claw coupling.

The upshift transmission can have a second shiftable connection. The second shiftable connection can be designed to connect the first gearwheel of the second gear set level on the one hand and the output shaft of the upshift transmission and/or the input shaft of the main transmission on the other hand in a rotationally fixed manner depending on the shift position. The second shiftable connection can be shiftable between a first shift position, in which the first gearwheel of the second gear set level on the one hand and the output shaft of the upshift transmission and/or the input shaft of the main transmission on the other hand are rotatable relative to each other, and a second shift position, in which the first gearwheel of the second gear set level on the one hand and the output shaft of the upshift transmission and/or the input shaft of the main transmission on the other hand are non-rotatably connected to each other. The second shiftable connection can be designed as a claw coupling.

The upshift transmission can have a third shiftable connection. The third shiftable connection can be designed to connect the first gearwheel of the third gear set level on the one hand and the output shaft of the upshift transmission and/or the input shaft of the main transmission on the other hand in a rotationally fixed manner depending on the shift position. The third shiftable connection can be shiftable between a first shift position, in which the first gearwheel of the third gear set level on the one hand and the output shaft of the upshift transmission and/or the input shaft of the main transmission on the other hand are rotatable relative to each other, and a second shift position, in which the first gearwheel of the third gear set level on the one hand and the output shaft of the upshift transmission and/or the input shaft of the main transmission on the other hand are non-rotatably connected to each other. The third shiftable connection can be designed as a claw coupling.

The upshift transmission can have a first shift element. The first shifting element can be designed to represent the first shiftable connection. The first shifting element can be designed as an axially displaceable claw shifting element. The upshift transmission can have a second shift element. The second shifting element can be designed to represent the second shiftable connection. The second shifting element can be designed to represent the third shiftable connection. The second shifting element can be designed as an axially displaceable claw shifting element.

The vehicle can be a motor vehicle, a passenger car, a truck, a commercial vehicle, an electric motor vehicle and/or a hybrid electric motor vehicle.

The invention increases safety and/or comfort. In addition, installation space requirements and/or costs can be reduced and/or efficiency increased.

### BRIEF DESCRIPTION OF THE DRAWINGS

In the following, embodiments of the invention are described in more detail with reference to figures, showing schematically and by way of example:

FIG. 1 a transmission shifting device with a shifting drum and two shifting elements, a parking lock and a parking lock shifting device with a cam gear in front view and in side view in a first rotational position,

FIG. 2 a transmission shifting device with a shifting drum and two shifting elements, a parking lock and a parking lock shifting device with a cam gear in front view and in side view in a second rotational position,

FIG. 3 a transmission shifting device with a shifting roller and two shifting elements, a parking lock and a parking lock shifting device with a cam gear in front view and in side view in a fourth rotational position,

FIG. 4 a transmission shifting device with a shifting roller and two shifting elements, a parking lock and a parking lock shifting device with a cam gear in front view and in side view in a sixth rotational position,

FIG. 5 a shifting sequence of shifting elements of a transmission shifting device with a parking lock shifting device when a shifting roller of the transmission shifting device is rotated,

FIG. 6 a transmission shifting device with a shifting drum and two shifting elements, a parking lock and a parking lock shifting device with a cam gear and an emergency release in front view and in side view in a first rotational position,

FIG. 7 a transmission shifting device with a shifting drum and two shifting elements, a parking lock and a parking lock shifting device with a cam gear and an emergency release in front view and in side view in a first further rotational position,

FIG. 8 a transmission shifting device with a shifting drum and two shifting elements, a parking lock and a parking lock shifting device with a cam gear and an emergency release in front view and in side view in a second further rotational position,

FIG. 9 a manual actuation for a parking lock shifting device in front view and in side view in a position detached from a cam element (top) and in a position connected to a cam element (bottom),

FIG. 10 a shifting sequence of shifting elements of a transmission shifting device with a parking lock shifting device with an emergency release when a shifting roller of the transmission shifting device is rotated,

FIG. 11 a differential transmission with a main transmission designed as a two-stage planetary transmission and an upshift transmission designed as a countershaft transmission, and

FIG. 12 a shift matrix for an upshift transmission of a transmission device with three shiftable connections for shifting three upshift gears.

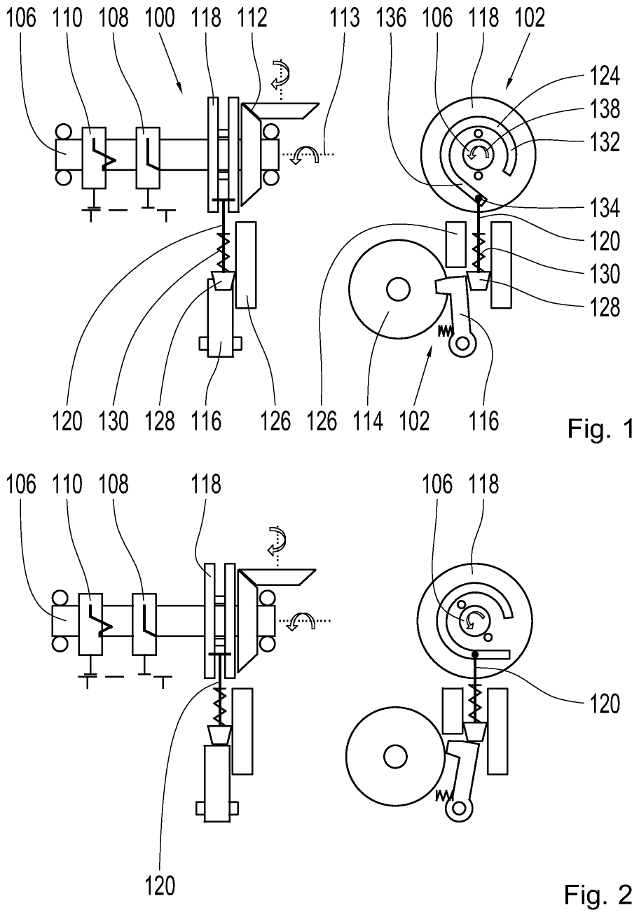

FIG. 1 shows a transmission shifting device 100, a parking lock 102 and a parking lock shifting device 104 in a first rotational position.

### DETAILED DESCRIPTION

The transmission shifting device 100 has a shift roller 106, a first shift element 108, a second shift element 110 and a drive with an actuator for automatically rotating the shift roller 106 and a bevel gear pair 112 and is designed for sequentially shifting gears of a transmission. The shift roller 106 is mounted on a housing of the transmission and can be rotated about an axis of rotation 113. The shifting roller 106 has guides for the shifting elements 108, 110 extending radially on the outside in the circumferential direction and/or in the axial direction. The shift elements 108, 110 are each mounted on the shift drum 106 and/or on the housing of the transmission in a rotationally fixed and axially displaceable manner and are guided on the guide of the shift drum 106.

The first shifting element 108 can be shifted into a neutral position and/or into a shifting position by rotating the shifting roller 106. The second shifting element 110 can be shifted into a first shifting position, into a neutral position and/or into a second shifting position by rotating the shifting roller 106.

The parking lock 102 has a parking lock wheel 114 and a parking lock pawl 116. The parking lock wheel 114 is non-rotatably connected to a shaft of a transmission and has a locking contour with recesses radially on the outside. The parking lock pawl 116 is displaceable between a release position, in which the parking lock 102 is released, and a locking position, in which the parking lock 102 is effective, and has a locking cam. In the release position, the locking cam is disengaged. In the locking position, the locking cam engages positively in the locking contour of the parking lock wheel 114.

The parking lock shifting device 102 has a flat cam mechanism with a cam element 118 and an engagement element 120 guided on the cam element 118 and displaceable for shifting the parking lock.

The cam element 118 is non-rotatably connected to the indexing roller 106 and can be rotated together with the indexing roller 106 about the axis of rotation 113. The cam element 118 has two cam disks which are parallel to one another, spaced apart from one another and connected to one another in a rotationally fixed manner and which each have a cam 124 formed with the aid of guide grooves on their sides facing one another.

The engagement element 120 has a shaped section that corresponds geometrically complementary to a cross-section of the guide grooves. The engagement element 120 is guided linearly with its shaped section in the guide grooves of the cam element 118 and on a housing 126 of the transmission. This means that the cam element 118 and the engagement element 120 can be moved in a common plane corresponding to the drawing plane. By turning the cam element 118, the engagement element 120 can be displaced radially relative to the cam element 118 and can be shifted between a release position, in which the parking lock 102 is released, and a locking position, in which the parking lock 102 becomes/is effective. The engagement element 120 forms a further shift element of the transmission shifting device 100, which can be shifted into a neutral position and/or into a shift position.

For actuating the parking lock pawl 116, the parking lock shifting device 104 has an actuating element 128 with a ramp section arranged on the engagement element 120 so as to be displaceable to a limited extent. A mechanical energy store 130 designed as a spring is active between the engagement element 120 and the actuating element 128. If the locking contour of the parking lock wheel 114 and the locking cam of the parking lock pawl 116 are not suitably aligned with one another when the engagement element 120 is shifted to its locking position, the spring is preloaded and the actuating element 128 is subsequently displaced into the locking position by spring force as soon as the locking contour of the parking lock wheel 114 and the locking cam of the parking lock pawl 116 are suitably aligned with one another.

The curve 124 extends radially spaced from the axis of rotation in the circumferential direction and/or in the radial direction and extends over an angular range of slightly more than 270°. The curve 124 has a cam section 132 with a constant distance from the axis of rotation 113 for holding the engagement element 120 in the release position, a cam end point 134 which is radially further apart from the axis of rotation 113 than the cam section 132, for holding the engagement element 120 in the locking position and between the cam section 132 and the cam end point 134 a cam section 136 with a linearly increasing or decreasing distance from the axis of rotation 113 for shifting the engagement element into the blocking position or into the release position.

When the cam element 118 is rotated in the direction of arrow 138, starting from the cam end point 134, in which the engagement element 120 is held in its locked position, first the cam section 136 and then the cam section 132 become effective, so that the engagement element 120 is first displaced into its release position and then held in its release position.

The shifting roller 106 and the cam element 118 can be rotated into the first rotational position shown in FIG. 1. In the first rotational position, the first shifting element 108 is shifted to its neutral position, the second shifting element 110 is shifted to its first shifting position and the engagement element 120 as a further shifting element is shifted to its shifting position or blocking position.

The shifting roller 106 and the cam element 118 can be rotated into the second rotational position shown in FIG. 2, in which the first shifting element 108 is shifted into its neutral position, the second shifting element 110 is shifted into its first shifting position and the engagement element 120 as a further shifting element is shifted into its neutral position or release position.

The shifting roller 106 and the cam element 118 can be rotated into a third rotational position, in which the first shifting element 108 is shifted into its neutral position, the second shifting element 110 is shifted into its neutral position and the engagement element 120 as a further shifting element is shifted into its neutral position or release position.

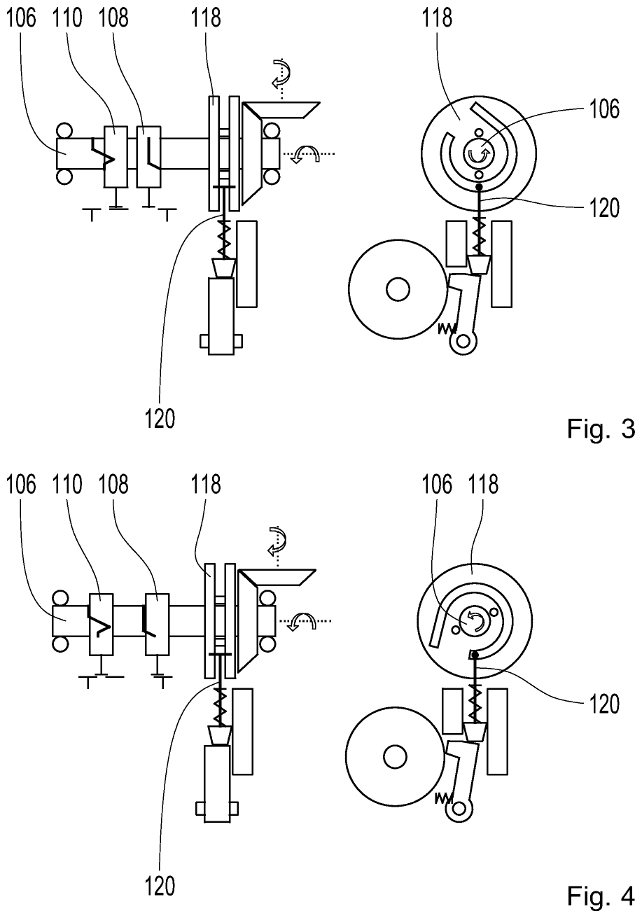

The shifting roller 106 and the cam element 118 can be rotated into the fourth rotational position shown in FIG. 3, in which the first shifting element 108 is shifted into its neutral position, the second shifting element 110 is shifted into its second shifting position and the engagement element 120 as a further shifting element is shifted into its neutral position or release position.

The shifting roller 106 and the cam element 118 can be rotated into a fifth rotational position, in which the first shifting element 108 is shifted to its neutral position, the second shifting element 110 is shifted to its neutral position and the engagement element 120 as a further shifting element is shifted to its neutral position or release position.

The shifting roller 106 and the cam element 118 can be rotated into the sixth rotational position shown in FIG. 4, in which the first shifting element 108 is shifted into its shifting position, the second shifting element 110 is shifted into its neutral position and the engagement element 120 as a further shifting element is shifted into its neutral position or release position.

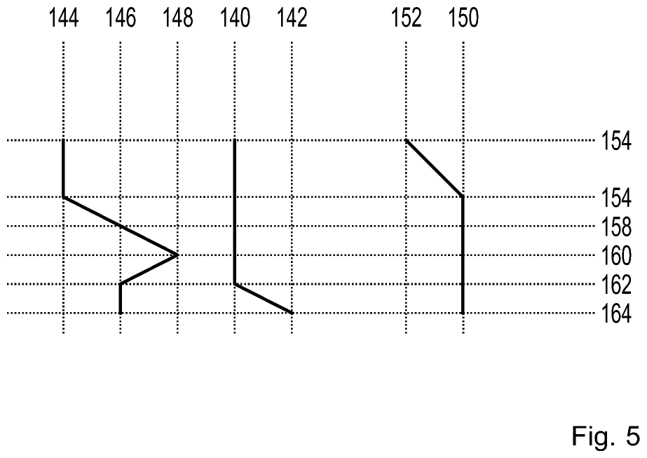

FIG. 5 shows a shifting sequence of the first shifting element 108, the second shifting element 110 and the engagement element 120 as a further shifting element when the shifting roller 106 and the cam element 118 are rotated.

The vertical line 140 marks the neutral position of the first shifting element 108. The vertical line 142 marks the shifting position of the first shifting element 108. The vertical line 144 marks the first shifting position of the second shifting element 110. The vertical line 146 marks the neutral position of the second shifting element 110. The vertical line 148 marks the second shifting position of the second shifting element 110. The vertical line 150 marks the neutral position or release position of the engagement element 120 as a further shifting element. The vertical line 152 marks the shifting position or locking position of the engagement element 120 as a further shifting element.

The horizontal line 154 marks the first rotational position 154 of the shifting roller 106, also shown in FIG. 1, in which the first shifting element 108 is shifted to its neutral position, the second shifting element 110 is shifted to its first shifting position and the engagement element 120 as a further shifting element is shifted to its shifting position or blocking position.

The horizontal line 156 marks the second rotational position of the shifting roller 106, also shown in FIG. 2, in which the first shifting element 108 is shifted to its neutral position, the second shifting element 110 is shifted to its first shifting position and the engagement element 120 as a further shifting element is shifted to its neutral position or release position.

The horizontal line 158 marks the third rotational position of the shifting roller 106, in which the first shifting element 108 is shifted to its neutral position, the second shifting element 110 is shifted to its neutral position and the engagement element 120 as a further shifting element is shifted to its neutral position or release position.

The horizontal line 160 marks the fourth rotational position of the shifting roller 106, also shown in FIG. 3, in which the first shifting element 108 is shifted to its neutral position, the second shifting element 110 is shifted to its second shifting position and the engagement element 120 as a further shifting element is shifted to its neutral position or release position.

The horizontal line 162 marks the fifth rotational position of the shifting roller 106, in which the first shifting element 108 is shifted to its neutral position, the second shifting element 110 is shifted to its neutral position and the engagement element 120 as a further shifting element is shifted to its neutral position or release position.

The horizontal line 164 marks the sixth rotational position of the shifting roller 106, also shown in FIG. 4, in which the first shifting element 108 is shifted to its shifting position, the second shifting element 110 is shifted to its neutral position and the engagement element 120 as a further shifting element is shifted to its neutral position or release position.

The first rotational position 154, the second rotational position 156, the third rotational position 158, the fourth rotational position 160, the fifth rotational position 162 and the sixth rotational position 164 are run through numerically ascending or descending sequentially and depending on the direction of rotation when the shift drum 106 is rotated.

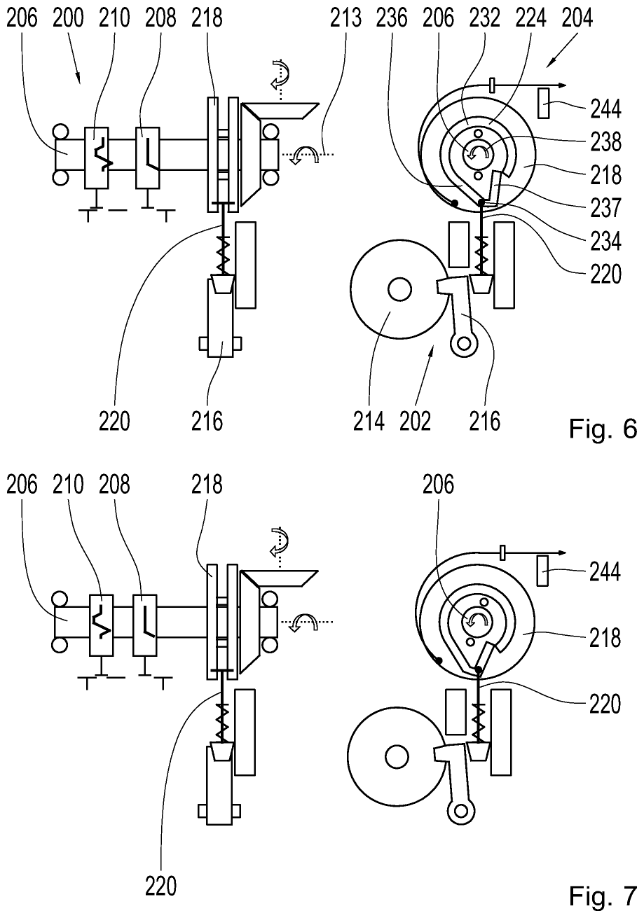

FIG. 6 shows a transmission shifting device 200, a parking lock 202 and a parking lock shifting device 204 with an emergency release in a first rotational position.

The transmission shifting device 200 has a shift drum 206 that can be rotated about an axis of rotation 213, a first shift element 208, a second shift element 210 and a drive with an actuator for automatically rotating the shift drum 206. The parking lock 202 has a parking lock wheel 214 and a parking lock pawl 216. The parking lock shifting device 202 has a flat cam mechanism with a cam element 218 and an engagement element 220 guided on the cam element 218 and displaceable for shifting the parking lock. The cam element 218 has a curve 224.

The curve 224 extends radially spaced from the axis of rotation in the circumferential direction and/or in the radial direction and extends over an angular range of approximately 360°. The curve 224 has a cam section 232 with a constant distance from the axis of rotation 213 for holding the engagement element 220 in the release position, a cam point 234 which is radially further apart from the axis of rotation 213 than the cam section 232 for holding the engagement element 220 in the locking position and between the cam section 232 and the cam point 234 a cam section 236 with a linearly increasing or decreasing distance from the axis of rotation 213 for shifting the engagement element into the blocking position or into the release position. The curve 224 also has a cam section 237 with a linearly decreasing or increasing distance from the axis of rotation 213 for emergency unlocking of the parking lock.

When the cam element 218 is rotated against the direction of arrow 238, the cam section 237 becomes effective starting from the cam point 234, in which the engagement element 220 is held in its locked position, so that the engagement element 220 is displaced to its release position and the parking lock is unlocked.

The shifting roller 206 and the cam element 218 can be rotated into the first rotational position shown in FIG. 6. In the first rotational position, the first shifting element 208 is shifted to its neutral position, the second shifting element 210 is shifted to its first shifting position and the engagement element 220 as a further shifting element is shifted to its shifting position or blocking position.

The shifting roller 206 and the cam element 218 can be rotated into the first further rotational position shown in FIG. 7, in which the first shifting element 208 is shifted into its neutral position, the second shifting element 210 is shifted into its neutral position and the engagement element 220 as a further shifting element is shifted into its shifting position or blocking position.

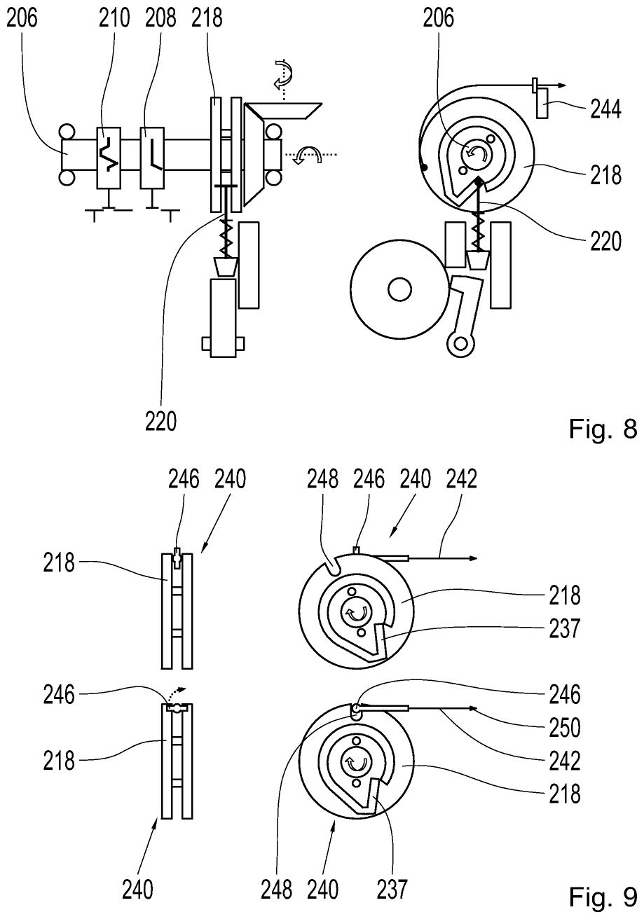

The shifting roller 206 and the cam element 218 can be rotated into the second further rotational position shown in FIG. 8, in which the first shifting element 208 is shifted into its neutral position, the second shifting element 210 is shifted into its neutral position and the engagement element 220 as a further shifting element is shifted into its neutral position or release position.

The parking lock shifting device 204 has a manual actuation 240 for rotating the cam element 218. Together with the cam section 237, the manual actuation 240 forms an emergency release with which the parking lock can be unlocked if actuation using the actuator is not possible. FIG. 9 shows details of manual actuation 240. The manual actuation 240 has a cable pull 242 and a pull limit 244 as shown in FIGS. 6 through 8. The manual actuation 240 is connectable to the cam element 218 and/or detachable from the cam element 218. For this purpose, the actuation 240 has a T-pin-shaped positive locking section 246 and the cam element 218 has a groove-shaped positive locking section 248. The positive locking portion 246 of the actuator 240 can be brought into or out of engagement with the positive locking portion 248 of the cam element 218 by rotating it through 90°.

For emergency unlocking of the parking lock 202, the manual actuation 240 is connected to the cam element 218 and the cam element 218 is rotated by pulling in the direction of arrow 250, so that the shifting roller 206 is manually adjusted into the first further rotational position and into the second further rotational position. For automated normal operation, the manual actuation 240 is released from the cam element 218 so that the shifting roller 206 and the cam element 218 can rotate freely.

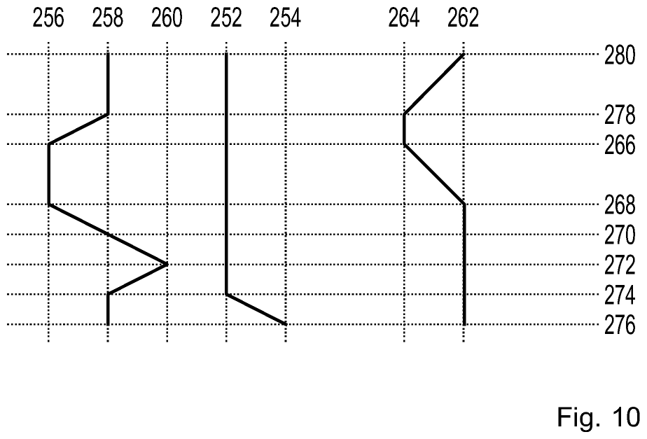

FIG. 10 shows a shifting sequence of the first shifting element 208, the second shifting element 210 and the engagement element 220 as a further shifting element when the shifting roller 206 and the cam element 218 are rotated.

The vertical line 252 marks the neutral position of the first shifting element 208. The vertical line 254 marks the shifting position of the first shifting element 208. The vertical line 256 marks the first shifting position of the second shifting element 210. The vertical line 258 marks the neutral position of the second shifting element 210. The vertical line 260 marks the second shifting position of the second shifting element 210. The vertical line 262 marks the neutral position or release position of the engagement element 220 as a further shifting element. The vertical line 264 marks the shifting position or locking position of the engagement element 220 as a further shifting element.

The horizontal line 266 marks the first rotational position of the shifting roller 206, also shown in FIG. 6, in which the first shifting element 208 is shifted to its neutral position, the second shifting element 210 is shifted to its first shifting position and the engagement element 220 as a further shifting element is shifted to its shifting position or blocking position.

The horizontal line 268 marks the second rotational position of the shifting roller 206, in which the first shifting element 208 is shifted to its neutral position, the second shifting element 210 is shifted to its first shifting position and the engagement element 220 as a further shifting element is shifted to its neutral position or release position.

The horizontal line 270 marks the third rotational position of the shifting roller 206, in which the first shifting element 208 is shifted to its neutral position, the second shifting element 210 is shifted to its neutral position and the engagement element 220 as a further shifting element is shifted to its neutral position or release position.

The horizontal line 272 marks the fourth rotational position of the shifting roller 206, in which the first shifting element 208 is shifted to its neutral position, the second shifting element 210 is shifted to its second shifting position and the engagement element 220 as a further shifting element is shifted to its neutral position or release position.

The horizontal line 274 marks the fifth rotational position of the shifting roller 206, in which the first shifting element 208 is shifted to its neutral position, the second shifting element 210 is shifted to its neutral position and the engagement element 220 as a further shifting element is shifted to its neutral position or release position.

Horizontal line 276 marks the sixth rotational position of the shifting roller 206, in which the first shifting element 208 is shifted to its shifting position, the second shifting element 210 is shifted to its neutral position and the engagement element 220 is shifted as a further shifting element to its neutral position or release position.

The horizontal line 278 marks the first further rotational position of the shifting roller 206, also shown in FIG. 7, in which the first shifting element 208 is shifted to its shifting position, the second shifting element 210 is shifted to its neutral position and the engagement element 220 as a further shifting element is shifted to its shifting position or blocking position.

The horizontal line 280 marks the second further rotational position of the shifting roller 206, also shown in FIG. 8, in which the first shifting element 208 is shifted to its neutral position, the second shifting element 210 is shifted to its neutral position and the engagement element 220 as a further shifting element is shifted to its neutral position or release position.

The first rotational position 266, the second rotational position 268, the third rotational position 270, the fourth rotational position 272, the fifth rotational position 274, the sixth rotational position 276, the first further rotational position 278 and the second further rotational position 280 are passed through sequentially and numerically in ascending or descending order depending on the direction of rotation when the shift drum 206 is rotated.

For the remainder, reference is made to the above description of the transmission shifting device 100, the parking lock 102 and the parking lock shifting device 104, which also describes the transmission shifting device 200, the parking lock 202 and the parking lock shifting device 204, for the structure and function of the transmission shifting device 200, the parking lock 202 and the parking lock shifting device 204.

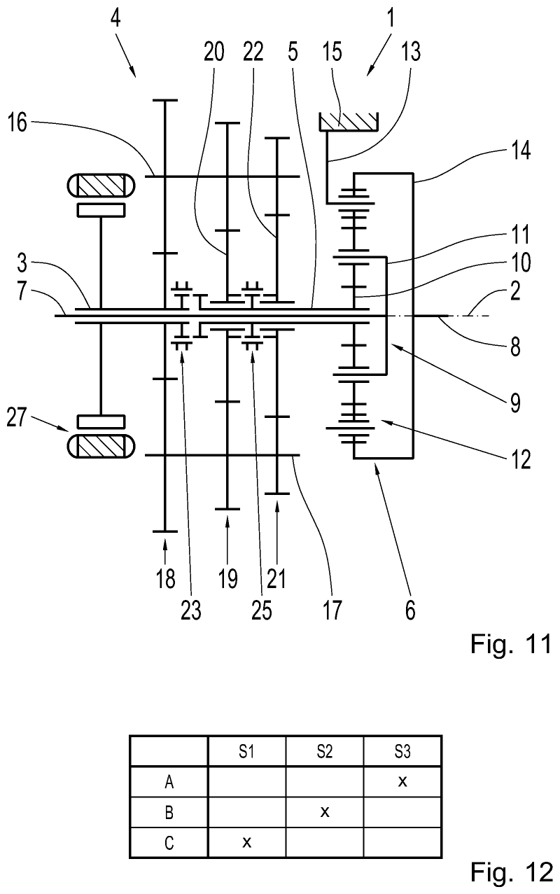

FIG. 11 shows a transmission 1 designed as a differential transmission which has the transmission shifting device 100, the parking lock 102 and the parking lock shifting device 104 or the transmission shifting device 200, the parking lock 202 and the parking lock shifting device 204.

The transmission 1 has a main shaft 2, an input shaft 3, an upshift transmission 4, an intermediate shaft 5, a main transmission 6, a first output shaft 7 and a second output shaft 8. The upshift transmission 4 is effective and arranged between the input shaft 3 and the main transmission 6.

The main transmission 5 has a first planetary gear set 9 with a sun gear 10, planet gears, a planet carrier 11 and a ring gear and a second planetary gear set 12 with a sun gear, planet gears, a planet carrier 13 and a ring gear 14. The first planetary gear set 9 is effective and arranged between the upshift transmission 4 and the second planetary gear set 12.

The intermediate shaft 5 and the sun gear 10 are non-rotatably connected to each other. The planet carrier 11 and the first output shaft 7 are non-rotatably connected to each other. The planet carrier 13 is non-rotatably connected to a housing 15 of the transmission 1. The ring gear 14 and the second output shaft 8 are non-rotatably connected to each other.

The upshift transmission 4 has a first countershaft 16 and a second countershaft 17. The upshift transmission 4 has a first gear set level 18 with a first gear wheel, which is non-rotatably connected to the input shaft 3, a second gear wheel, which is non-rotatably connected to the first countershaft 16, and a second gear wheel, which is non-rotatably connected to the second countershaft 17. The upshift transmission 4 has a second gear set level 19 with a first gear wheel 20, which is rotatably arranged on the intermediate shaft 5, a second gear wheel, which is non-rotatably connected to the first countershaft 16, and a second gear wheel, which is non-rotatably connected to the second countershaft 17. The upshift transmission 4 has a third gear set level 21 with a first gear wheel 22, which is rotatably arranged on the intermediate shaft 5, a second gear wheel, which is non-rotatably connected to the first countershaft 16, and a second gear wheel, which is non-rotatably connected to the second countershaft 17.

Upshift transmission 4 has a first shift element 23, which is designed as an axially displaceable claw shift element and is designed to provide a first shiftable connection between input shaft 3 and intermediate shaft 5. The first shifting element 23 can be shifted between a first shifting position and a second shifting position. In the first shifting position, the input shaft 3 and the intermediate shaft 5 can be rotated relative to each other. In the second shifting position, the input shaft 3 and the intermediate shaft 5 are non-rotatably connected to each other.

The upshift transmission 4 has a second shift element 24 designed as an axially displaceable claw shift element,

The upshift transmission 4 has a second shift element 25, which is designed as an axially displaceable claw shift element and is designed to provide a second shiftable connection between the first gearwheel 20 and the intermediate shaft 5 and a third shiftable connection between the first gearwheel 22 and the intermediate shaft 5. The second shifting element 24 can be shifted between a first shifting position, a second shifting position and a third shifting position. In the first shift position, the first gearwheel 20 and the intermediate shaft 5 are non-rotatably connected to each other and the second gearwheel 22 and the intermediate shaft 5 can rotate relative to each other. In the second shift position, both the first gearwheel 20 and the intermediate shaft 5 as well as the second gearwheel 22 and the intermediate shaft 5 can be rotated relative to each other. In the third shift position, the first gearwheel 20 and the intermediate shaft 5 can rotate relative to each other and the second gearwheel 22 and the intermediate shaft 5 are connected to each other in a rotationally fixed manner.

FIG. 12 shows a shift matrix for the upshift transmission 4 of the transmission 1 with the first shiftable connection S1, the second shiftable connection S2 and the third shiftable connection S3 for shifting the first upshift gear A, the second upshift gear B and the third upshift gear C. In the shifting matrix according to FIG. 2, the upstream gears A, B, C are shown in rows and the shiftable connections S1, S2, S3 in columns. In the shifting matrix, “X” indicates a closed shifting position of a connection. A closed connection enables mechanical power transmission. An open connection does not transmit any mechanical power.

In the first upshift gear A, connection S3 is closed, while the other connections S1, S2 are open, so that the first upshift gear A is represented by means of the first wheel set level 18 and the third wheel set level 21. In the upshift gear B, the connection S2 is closed, while the other connections S1, S3 are open, so that the upshift gear B is represented by the first wheel set level 18 and the second wheel set level 19. In the upshift gear C, the connection S1 is closed, while the other connections S2, S3 are open, so that the third upshift gear C is shown as a direct gear between the upshift transmission 4 and the main transmission 6.

For example, the main transmission has a transmission ratio i≈7.86, the first gear set level 18 has a transmission ratio i≈1.2, the second gear set level 19 has a transmission ratio i≈1.54 and the third gear set level 21 has a transmission ratio i≈3.15. This means that the first upstream gear A has a transmission ratio i≈29.7, the second upstream gear B has a transmission ratio i≈14.5 and the third upstream gear C has a transmission ratio i≈7.86.

The input shaft 3 can be driven by means of an electric drive machine 27, whose stator is connected to the housing 15 and whose rotor is connected to the input shaft 3 in a rotationally fixed manner.

### LIST OF REFERENCE NUMERALS

100 Transmission shifting device
102 Parking lock
104 Parking lock shifting device
106 shifting roller
108 first shift element
110 second shift element
112 Bevel gear pairing
113 Rotary axis
114 Parking lock wheel
116 parking lock pawl
118 Cam element
120 Engagement element
124 Curve
126 Housing
128 Actuator element
130 Mechanical energy storage
132 Cam section
134 Cam end point
136 Cam section
138 Arrow direction
140 Neutral position of the first shift element
142 shift position of the first shift element
144 first shift position of the second shift element
146 Neutral position of the second shift element
148 second shift position of the second shift element
150 Neutral positioning of the engagement element
152 shift position of the engagement element
154 first rotary position
156 second rotary position
158 third rotary position
160 fourth rotary position
162 fifth rotary position
164 sixth rotary position
200 transmission shifting device
202 Parking lock
204 Parking lock shifting device
206 shifting roller
208 first shift element
210 second shift element
213 Rotary axis
214 Parking lock wheel
216 Parking lock pawl
218 Cam element
220 Engagement element
224 Curve
232 Cam section
234 Cam point
236 Cam section
237 Cam section
238 Direction of arrow
240 Manual operation
242 Rope pull
244 Pull limitation
246 Form closure section
248 form closure section
250 Arrow direction
252 neutral position of the first shift element
254 shift position of the first shift element
256 first shift position of the second shift element
258 Neutral position of the second shift element
260 second shift position of the second shift element
262 Neutral position of the engagement element
264 shift position of the engagement element
266 first rotary position
268 second rotary position
270 third rotary position
272 fourth rotary position
274 fifth rotary position
276 sixth rotary position
278 First further rotary position
280 Second additional rotational position
1 Transmission
2 Main axis
3 Input shaft
4 Upshift transmission
5 Intermediate shaft
6 Main transmission
7 first output shaft
8 second output shaft
9 First planetary gear set
10 Sun gear
11 Planet carrier
12 Second planetary gear set
13 Planet carrier
14 Ring gear
15 Housing
16 First countershaft
17 Second countershaft
18 First gear set level
19 second gear set plane
20 first gear wheel
21 third gear set plane
22 first gear wheel
23 first shift element
25 Second shift element
27 electrical drive machine
S1 first shiftable connection
S2 second shiftable connection
S3 third shiftable connection
A first upshift gear
B second upshift gear
C third upshift gear

1. A parking lock shifting device (104, 204), comprising:
a flat cam mechanism with a rotatable cam element (118, 218); and
an engagement element (120, 220) guided on the cam element (118, 218) and configured to be displaced for shifting a parking lock (102, 202).

2. The parking lock shifting device (104, 204) according to claim 1, wherein the engagement element (120, 220) is displaceable between a release position, in which the parking lock (102, 202) is released, and a locking position, in which the parking lock (102, 202) is effective.

3. The parking lock shifting device (104, 204) according to claim 1, wherein the cam element (118, 218) has a cam (124, 224) with a first cam section (132, 232) configured for holding the engagement element (120, 220) in a release position, a second cam section (136, 236) configured for shifting the engagement element into a blocking position, a third cam section (134, 234) configured for holding the engagement element in the blocking position and/or a fourth cam section (136, 236) configured for shifting the engagement element (120, 220) into the release position.

4. The parking lock shifting device (204) according to claim 1, wherein the cam element (218) has a cam (224) with a further cam section (237) configured for emergency unlocking of the parking lock (202).

5. The parking lock shifting device (204) according to claim 1, wherein the parking lock shifting device (204) comprises an actuator for automatically rotating the cam element (218) and/or a manual actuation (240) for rotating the cam element (218).

6. The parking lock shifting device (204) according to claim 5, wherein the manual actuation (240) can be connected to the cam element (218) and/or can be released from the cam element (218).

7. The parking lock shifting device (104, 204) according to claim 1, wherein the parking lock shifting device (104, 204) comprises:
an actuating element (128) connected to the engagement element (120, 220) and configured to be displaced to a limited extent relative to the engagement element (120, 220); and
a mechanical energy store (130) effective between the engagement element (120, 220) and the actuating element (128).

8. A transmission shifting device (100, 200) comprising:
a rotatable shift drum (106, 206);
at least one shift element (108, 110, 208, 210, 23, 25) configured to be displaced by rotating the shift drum (106, 206); and
a parking lock shifting device (104, 204) according to claim 1;
wherein the cam element (118, 218) is non-rotatably connected to the shift drum (106, 206) and the engagement element (120, 220) forms a further shift element which can be shifted by rotating the shift drum (106, 206).

9. The transmission shifting device (100, 200) according to claim 8, comprising:
a first shifting element (108) configured to be shifted into a neutral position and/or into a shifting position by rotating the shifting drum (106, 206). 208, 23) and
a second shifting element (110, 210, 25) configured to be shifted into a first shifting position, into a neutral position, and/or into a second shifting position by rotating the shifting drum (106, 206);
wherein the further shifting element can be shifted into a neutral position and/or or can be shifted to a shifting position.

10. The transmission shifting device (100, 200) according to claim 9, wherein:
the shift drum (106, 206) can be automatically rotated into a first rotational position (154, 266), in which the first shift element (108, 208, 23) is shifted into its neutral position (140, 252), the second shift element (110, 210, 25) is shifted into its first shift position (144, 256) and the further shift element is shifted into its shift position (152, 264)
the shift drum (106, 206) can be automatically rotated into a second rotational position (156, 268), in which the first shift element (108, 208, 23) is shifted into its neutral position (140, 252), the second shift element (110, 210, 25) is shifted into its first shift position (144, 256) and the further shift element is shifted into its neutral position (150, 262);
the shift drum (106, 206) can be automatically rotated into a third rotational position (158, 270), in which the first shift element (108, 208, 23) is shifted into its neutral position (140, 252), the second shift element (110, 210, 25) is shifted into its neutral position (146, 258) and the further shift element is shifted into its neutral position (150, 262);
the shift drum (106, 206) can be automatically rotated into a fourth rotational position (160, 272), in which the first shift element (108, 208, 23) is shifted into its neutral position (140, 252), the second shift element (110, 210, 25) is shifted into its second shift position (148, 260) and the further shift element is shifted into its neutral position (150, 262);
the shift drum (106, 206) can be automatically rotated into a fifth rotational position (162, 274), in which the first shift element (108, 208, 23) is shifted into its neutral position (140, 252), the second shift element (110, 210, 25) is shifted into its neutral position (146, 258) and the further shift element is shifted into its neutral position (150, 262); and/or
the shift drum (106, 206) can be automatically rotated into a sixth rotational position (164, 276), in which the first shift element (108, 208, 23) is shifted into its shift position (142, 254), the second shift element (110, 210, 25) is shifted into its neutral position (146, 258) and the further shift element is shifted into its neutral position (150, 262).

11. The transmission shifting device (200) according to claim 10, wherein the shift drum (206) can be rotated manually into a first further rotational position (278), in which the first shift element (208, 23) is shifted into its neutral position (252), the second shift element (210, 25) is shifted into its neutral position (258) and the further shifting element is shifted into its shifting position (264), and/or into a second further rotational position (280) in which the first shifting element (208, 23) is shifted into its neutral position (252), the second shifting element (210, 25) is shifted into its neutral position (258) and the further shifting element is shifted into its neutral position (262).

12. A transmission comprising:
a parking lock shifting device (104, 204) according to claim 1.

13. The transmission (1) according to claim 12, comprising an input shaft (3) and wherein the parking lock (102, 202) is arranged on the input shaft (3).

14. A vehicle comprising the parking lock shifting device (104, 204) according to claim 1.

15. A transmission comprising the transmission shifting device (100, 200) according to claim 8.

16. A vehicle comprising the transmission shifting device (100, 200) according claim 8.

17. A vehicle comprising the transmission (1) according to claim 12.
